(19) United States
(12) Patent Application Publication
(10) Pub. No.: US 2025/0037335 A1
(43) Pub. Date: Jan. 30, 2025

(54) VIDEO PROCESSING METHOD, APPARATUS, ELECTRONIC DEVICE AND STORAGE MEDIUM

(71) Applicant: Beijing Zitiao Network Technology Co., Ltd., Haidian District (CN)

(72) Inventor: Jing LU, Beijing (CN)

(21) Appl. No.: 18/760,293

(22) Filed: Jul. 1, 2024

(30) Foreign Application Priority Data
Jul. 24, 2023 (CN) 202310913189.2

(51) Int. Cl. G06T 11/60; G06F 3/0483; G06F 3/0484; G11B 27/031

(52) U.S. Cl. CPC G06T 11/60; G06F 3/0483; G06F 3/0484; G11B 27/031; G06T 2200/24

(57) ABSTRACT

The present disclosure relates to a video processing method, apparatus, electronic device and storage medium. The video processing method comprises: receiving input content; the input content used for characterizing video production requirements; generating an initial video script based on the input content, the initial video script including video production outlines and video production elements corresponding to the video production outlines, the video production elements including shooting information and copywriting content corresponding to the video production outlines, the shooting information including at least one of a shooting location, a shooting angle, a shooting prop and a shooting sample material, the initial video script being used to assist a video creator in video creation; and displaying the initial video script on a first page.

### CROSS-REFERENCE TO RELATED APPLICATION(S)

This application claims priority to Chinese Application No. 202310913189.2 filed on Jul. 24, 2023, the disclosure of which is incorporated herein by reference in its entirety.

### FIELD

The present disclosure relates to the field of video technology, and in particular, to a video processing method, apparatus, electronic device, and storage medium.

### BACKGROUND

A video script refers to an underlying manuscript upon which a video is created. When a video creator wants to create/produce a video, the creator first manually edits a corresponding video script according to their own needs for creating the video, and then completes the video creation according to the video script.

However, the above method of editing video scripts by video creators will consume a lot of time and energy of the video creators, making high video creation cost and low video creation efficiency.

### SUMMARY

In order to solve the above technical problems, the present disclosure provides a video processing method, apparatus, electronic device and storage medium.

In a first aspect, an embodiment of the present disclosure provides a video processing method, the method comprising:
receiving input content, the input content used for characterizing video production requirements;
generating an initial video script based on the input content, the initial video script including video production outlines and video production elements corresponding to the video production outlines, the video production elements including shooting information and copywriting content corresponding to the video production outlines, the shooting information including at least one of a shooting location, a shooting angle, a shooting prop and a shooting sample material, the initial video script being used to assist a video creator in video creation; and displaying the initial video script on a first page.

In a second aspect, an embodiment of the present disclosure further provides a video processing apparatus, the apparatus comprising:
an input content receiving module, configured to receive input content, the input content used for characterizing video production requirements;
a first video script generation module, configured to generate an initial video script based on the input content, the initial video script including video production outlines and video production elements corresponding to the video production outlines, the video production elements including shooting information and copywriting content corresponding to the video production outlines, the shooting information including at least one of a shooting location, a shooting angle, a shooting prop and a shooting sample material, the initial video script being used to assist a video creator in video creation; and a video script display module, configured to display the initial video script on a first page.

In a third aspect, an embodiment of the present disclosure further provides an electronic device, the electronic device comprising:
a processor; and
a memory for storing executable instructions, wherein the processor is configured to read the executable instructions from the memory and execute the executable instructions to implement the video processing method described in any embodiment of the present disclosure.

In a fourth aspect, the disclosure provides a computer-readable storage medium having a computer program stored thereon, which, when executed by a processor, causes the processor to implement the video processing method described in any embodiment of the disclosure.

The video processing method, apparatus, electronic device and storage medium of the embodiments of the present disclosure enable video creators to edit input content according to their own video production requirements in a scenario where video scripts are automatically generated. A video creator only needs to input the input content once, and then a video processing apparatus can generate a video script according to the input content. The video script includes video production outlines and its corresponding video production elements. The video production elements include copywriting content and at least one of a shooting location, a shooting angle, a shooting prop and a shooting sample material. The video script includes a wide variety of information, which can comprehensively assist video creators in video creation, reduce the requirement for video creators to have relevant professional knowledge in editing scripts, save time and energy for video creators, improve the efficiency of video script generation, and reduce the cost of video creation, thereby can efficiently assist video creators in video creation.

### BRIEF DESCRIPTION OF THE DRAWINGS

The above and other features, advantages, and aspects of various embodiments of the present disclosure will become more apparent with reference to the following detailed description taken in conjunction with the accompanying drawings. Throughout the drawings, the like or similar reference numbers indicate the like or similar elements. It is to be understood that the drawings are schematic and that originals and elements are not necessarily drawn to scale.

FIG. 1 is a schematic flowchart of a video processing method provided by an embodiment of the present disclosure;

FIG. 2 is a schematic diagram of inputting video production copywriting in a form of a dialog box provided by an embodiment of the present disclosure;

FIG. 3 is a schematic diagram of inputting a video production theme in a form of a dialog box provided by an embodiment of the present disclosure;

FIG. 4 is a schematic diagram of an initial video script displayed in a target structured style provided by an embodiment of the present disclosure;

FIG. 5 is a schematic flowchart of generating target video content provided by an embodiment of the present disclosure;

FIG. 6 is a schematic diagram of a video production interface provided by an embodiment of the present disclosure;

FIG. 7 is a schematic flowchart of another video processing method provided by an embodiment of the present disclosure;

FIG. 8 is a schematic diagram of performing a global modification operation on an initial video script provided by an embodiment of the present disclosure;

FIG. 9 is a schematic diagram of performing an addition operation on an initial video script provided by an embodiment of the present disclosure;

FIG. 10 is a schematic diagram of performing an operation on a shooting control or a material selection control provided by an embodiment of the present disclosure;

FIG. 11 is a schematic structural diagram of a video processing apparatus provided by an embodiment of the present disclosure;

FIG. 12 is a schematic structural diagram of an electronic device provided by an embodiment of the present disclosure.

### DETAILED DESCRIPTION OF EMBODIMENTS

Embodiments of the present disclosure will be described in more detail below with reference to the accompanying drawings. Although certain embodiments of the present disclosure are shown in the drawings, it should be understood that the present disclosure may be implemented in various forms and should not be construed as limited to the embodiments set forth herein, which rather are provided for a more thorough and complete understanding of the present disclosure. It should be understood that the drawings and embodiments of the present disclosure are for illustrative purposes only and are not intended to limit the protection scope of the present disclosure.

It should be understood that various steps recited in the method implementations of the present disclosure may be executed in different orders and/or executed in parallel. Furthermore, method implementations may include additional steps and/or omit performance of illustrated steps. The scope of the present disclosure is not limited in this respect.

As used herein, the term “include” and its variations are open-ended, i.e., “including but not limited to.” The term “based on” means “based at least in part on.” The term “one embodiment” means “at least one embodiment”; the term “another embodiment” means “at least one additional embodiment”; and the term “some embodiments” means “at least some embodiments”. Relevant definitions of other terms will be given in the description below.

It should be noted that concepts such as “first” and “second” etc. mentioned in the present disclosure are only used to distinguish different apparatus, modules or units, and are not used to limit the order of functions performed by these apparatus, modules or units or interdependence.

It should be noted that modifications of “one” and “a plurality of” mentioned in the present disclosure are illustrative and not restrictive. Those skilled in the art should understand that they should be construed as “one or more” unless context clearly indicates otherwise.

The names of messages or information interacted between a plurality of apparatus in the embodiments of the present disclosure are for illustrative purposes only and are not used to limit the scope of these messages or information.

A video script refers to an underlying manuscript upon which a video is created. In related arts, corresponding video scripts are primarily edited manually by video creators according to their own needs for video creation, and then the video creation is completed according to the video scripts.

In order to reduce labor costs, video creators may also perform human-computer interaction with a generative model to generate scripts. However, in this method, the video creators and the generative model need to interact in multiple rounds, and it is time-consuming in this method. And in each round of interaction, video creators are required to input accurate instructions that can express their own needs. This requires video creators to master correct instructions for interacting with the generative model, and they need to master accurate skills to express their own needs to the model. Video creators using this method need to pay higher instruction learning costs and demand expression learning costs for interacting with the model.

In addition, many script templates may be generated in advance through the model, so that video creators may filter out script templates they need from many script templates according to their own needs. In this method, video creators need to master methods and processes for filtering script templates, which consumes a lot of time and energy. Moreover, various pre-generated script templates cannot well meet video production requirements of video creators.

In summary, all of the above methods consume a lot of time and energy from video creators, are time-consuming and labor-intensive, and have problems of high creation costs and low creation efficiency.

In view of the above situation, an embodiment of the present disclosure provides a video processing solution to enable video creators to enter input content once, and to obtain a video script generated based on the input content, which reduces the requirement for video creators to have script expertise, improves the efficiency of generating a video script, saves the time and energy of video creators, and reduces the cost of video creation, thereby can efficiently assist video creators in video creation.

The video processing method provided by the embodiment of the present disclosure may be applied to scenarios where video scripts are automatically generated according to input from video creators. The method may be executed by a video processing apparatus or a client, the apparatus may be implemented in software and/or hardware, and may be integrated into an electronic device with a display function. The electronic device may include but not limited to a mobile terminal such as a smartphone, a laptop, a Personal Digital Assistant (PDA), a Tablet Personal Computer (Tablet PC), a PMP (portable multimedia player), a wearable device, etc., and a fixed terminal such as a digital TV, a desktop computer, etc.

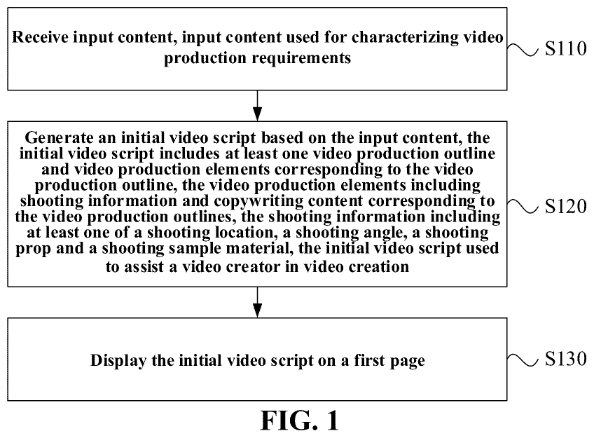

FIG. 1 illustrates a schematic flowchart of a video processing method provided by an embodiment of the present disclosure. As shown in FIG. 1, the video processing method may comprise the following steps.

S110. Receiving input content, the input content being used for characterizing video production requirements.

The input content may be content input by a video creator. The video production requirements may be requirements of the video creator for a final generated video content in one or more dimensions.

In one example, input content may be content edited by a video creator and input into a video processing apparatus. There are many input methods for the input content, which are not limited in the embodiment. For example, the input method for the input content may be touch input, or the input method for the input content may be voice input. There are many formats of the input content, which is also not limited in the embodiment. For example, the format of the input content may be text format, voice format, etc.

In another example, input content may also be content input by jumping from other page or application. For example, text that can characterize video production requirements is embedded in the other page or application in a form of a hyperlink pointing to a video processing apparatus. When a video creator triggers the hyperlink text, the video processing apparatus is triggered to start, and corresponding text is the input content.

In an alternative implementation, input content includes a video production theme or video production copywriting. The video production theme may be understood as central content or main content of a video. The embodiment does not limit the video production theme. For example, the video production theme may be a travel guide for a certain place or shooting skills for a certain store. The video production copywriting may be complete script copywriting for video production, which may be understood as a text version of a video production script, so the video production copywriting may include the lines/subtitles of a video. In this way, it is possible to be compatible with input contents from video creators with different levels of detail, further reducing the requirements for video creators to have professional knowledge reserves, thereby further improving the convenience of video script production.

In an embodiment of the present disclosure, a video creator may edit input content that can express their own video production requirements. The video creator may input the input content directly into a video processing apparatus, or the video creator may input the input content into other page or application and trigger a hyperlink text in the other page or application pointing to a video processing apparatus, and the other page or application sends the input content to the video processing apparatus. Accordingly, the video processing apparatus receives the input content.

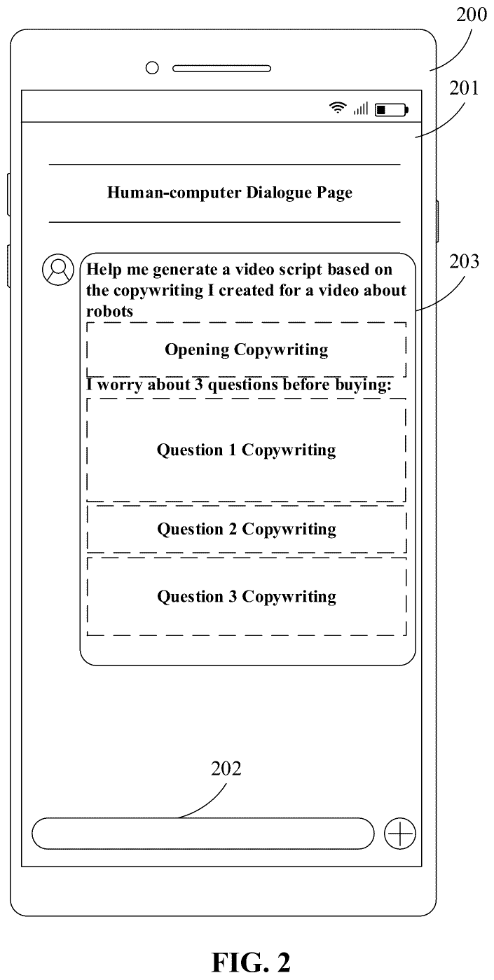

In an alternative implementation, a video processing apparatus may perform human-computer interaction with a video creator in a form of a dialog box. FIG. 2 is a schematic diagram of inputting video production copywriting in a form of a dialog box provided by an embodiment of the present disclosure. As shown in FIG. 2, a first page 201 is displayed on an electronic device 200, and the first page 201 may be understood as a human-computer dialogue page. An input box 202 and a user session box 203 are displayed on the first page 201. A video creator may enter text content including video production copywriting in the input box 202 and send the text content. Afterwards, the user session box 203 is displayed on the first page 201, and the text content including the video production copywriting is displayed in the user session box 203. As shown in FIG. 2, the text content may include a text part expressing the need to generate a video script, and the video production copywriting. The video production copywriting includes many parts: an opening copywriting part, a copywriting part expressing a specific question, etc.

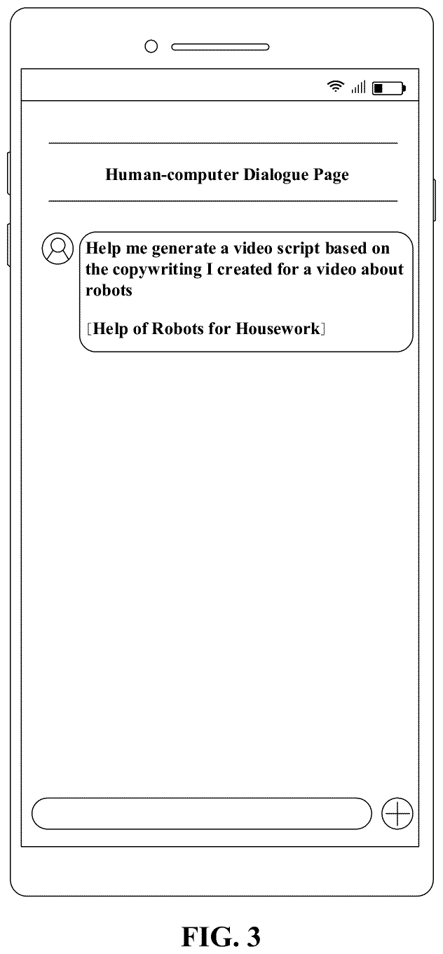

FIG. 3 is a schematic diagram of inputting a video production theme in a form of a dialog box provided by an embodiment of the present disclosure. As shown in FIG. 3, a video creator may enter text content including a video production theme in an input box and send the text content. Afterwards, a user session box is displayed on a first page, and the text content including the video production theme is displayed in the user session box. As shown in FIG. 3, the text content may include a text part expressing the need to generate a video script, as well as the video production theme. The video production theme is “The Assistance of Robots in Housework”.

S120. Generating an initial video script based on the input content, wherein the initial video script includes at least one video production outline and video production elements corresponding to the video production outline, the video production elements including shooting information and copywriting content corresponding to the video production outline, the shooting information including at least one of a shooting location, a shooting angle, shooting props and shooting example materials; the initial video script is used to assist a video creator in video creation.

A video script may be an underlying manuscript recording the development of a video. An initial video script may be a video script generated directly based on input content and not processed by a video creator.

A video production outline may characterize one or more key points corresponding to a video. The video production outline may include one or more outline items, which may be one-to-one correspondence with key points. The embodiment does not limit the number of outline items included in the video production outline. If there are a plurality of outline items, the plurality of outline items may have a temporal relationship and/or a logical relationship among them. The video production outline may be content for briefly introducing video production sequence and/or steps. The embodiment does not limit introduction dimensions of the video production outline. For example, the introduction dimensions of the video production outline may include at least one of a sequence dimension and a shot dimension. If the introduction dimensions of the video production outline includes a sequence dimension, the video production outline may include the beginning of a video and/or the end of the video. If the introduction dimensions of the video production outline includes a shot dimension, the video production outline may include a zoom transition and/or a fade transition.

There are many methods for determining the video production outline, which are not limited in the embodiment. For example, if the input content includes video production copywriting, the video production outline may be determined according to semantic division of the video production copywriting; alternatively, the video production outline may be determined based on video storyboard division.

The video production elements may have one-to-one correspondence with the outline items in the video production outline. The video production elements may be specific description information corresponding to the outline items in the video production outline. The video production elements may be information that records characteristics of the outline items in the video production outline. The video production elements may include shooting information and copywriting content.

The shooting information may be information that records how to shoot to obtain video clips, and may include at least one of a shooting location, a shooting angle, shooting props, and shooting sample materials. The shooting location may be a filming position for shooting. The embodiment does not limit the granularity of the shooting location. The granularity of the shooting location may correspond to video production requirements. As an example, if video production requirements characterized by input content are related to a scenic region, the shooting location may be one or more scenic spots in the scenic region; if the video production requirements are related to a home appliance, the shooting location may include one or more of home entire scene, home area scene and the appliance details.

The shooting angle may include at least one of the angle between the photographed object and the lens and the angle of view of the shooting lens. If the shooting angle includes the angle of view of the shooting lens, the shooting angle may be wide angle or super wide angle. The shooting props may be physical items used in the process of shooting video clips, and the embodiment does not limit the shooting props. For example, the shooting props may include physical scenery and/or items for dressing up the characters, etc., and the items for dressing up the characters may include clothing, accessories, and hand-held objects, among others.

The shooting sample material may be a recommended video clip, and the shooting sample material may be a shooting sample material determined by automatic matching based on part of the input content corresponding to the video production outline. There are many kinds of sources of the shooting sample materials, which are not limited in the embodiment. For example, the shooting sample material may be a video clip crawled from the Internet.

The copywriting content may be video lines/subtitles copywriting corresponding to the video production outline. There are many ways to determine the copywriting content, which are not limited in the embodiment. For example, if the input content includes a video production theme, the copywriting content may be content determined by semantic division of the copywriting generated according to the video production theme; if the input content includes the video production copywriting, the copywriting content may be content determined by semantic division of the video production copywriting. Take the opening copywriting in FIG. 2 as an example. The opening copywriting may be divided into two copywriting segments based on semantics: opening copywriting segment 1 and opening copywriting segment 2. These two copywriting segments serve as copywriting content corresponding to two adjacent video production outlines.

In the embodiment of the present disclosure, the video creator edits input content according to their own video production requirements, and inputs the input content into a video processing apparatus. After receiving the input content, the video processing apparatus determines at least one video production outline corresponding to the input content, as well as shooting information and copywriting content corresponding to each outline item in the video production outline. The shooting information includes at least one of a shooting location, a shooting angle, shooting props and shooting sample material. The at least one video production outline and the shooting information and copywriting content corresponding to the video production outlines constitute an initial video script.

In some embodiments of the present disclosure, generating an initial video script based on the input content comprises: generating an initial video script based on a video type corresponding to the input content, wherein the video production outline and the video production elements in the initial video script have a correspondence relationship with the video type.

The video type may be content classification of a video, and the video type may characterize a vertical field to which the video belongs. There are multiple video types, and the embodiment does not limit the video types. For example, the video type may include one or more of food type, travel type, and knowledge type.

In the present embodiment, the input content may be a video production theme or a video production copywriting, and the video processing apparatus may determine the video type corresponding to the input content by performing semantic analysis on the input content. Further, the video processing apparatus may generate an initial video script according to the video type, or the video processing apparatus may process the video type and input content comprehensively to generate an initial video script.

Hereinafter, take video types being food type, travelling type, and knowledge type respectively as examples to illustrate initial video scripts corresponding to different video types.

Example 1: if the video type is food type, the video production outline may include outline items such as raw materials of food and production methods of the food. Shooting information corresponding to the raw materials of the food may include an introduction that the shooting location is a vegetable market, the shooting angle is macro shooting, and the copywriting content corresponding to the raw materials of the food may be the raw materials. The shooting information corresponding to the food production method may include that shooting location is in kitchen, shooting props are cooking utensils, shooting sample material is production video of the food based on network matching, and the copywriting content corresponding to the food production method may be texts obtained by voice recognition of the production video.

Example 2: if the video type is travelling type, the video production outline may include outline items such as scenic spot 1 and scenic spot 2 on tourist routes in a scenic region. The shooting information corresponding to scenic spot 1 may include an introduction that the shooting location is a specific location of scenic spot 1, the shooting angle is wide-angle shooting, and the copywriting content corresponding to scenic spot 1 may be scenic spot 1. The shooting information corresponding to scenic spot 2 may include an introduction that the shooting location is a specific location of scenic spot 2, the shooting angle is ultra-wide-angle shooting, the shooting props are handheld props, and the copywriting content corresponding to scenic spot 2 may be scenic spot 2.

Example 3: if the video type is knowledge type, the video production outline may include outline items such as raising questions and solving problems. The shooting information corresponding to raising questions may include shooting sample materials, which are videos produced based on pictures by network matching, and the copywriting content corresponding to raising questions may be an introduction to the knowledge background. The shooting information corresponding to solving problems may include an introduction that shooting location is in laboratory, shooting angle is macro shooting, and shooting props are experimental props. The copywriting content corresponding to solving problems may be an introduction to the experimental process.

In the above solution, a video script is generated according to the video type of the input content, so that the style of the video script matches the input content well.

In some embodiments of the present disclosure, an initial video script may be generated through a model. Specifically, generating an initial video script based on a video type corresponding to input content comprises: identifying a video type corresponding to input content using a preset script generation model; generating an initial video script using the preset script generation model based on a video production style corresponding to the video type and a keyword of the input content, wherein the video production style is used for characterizing correspondence relationship.

The preset script generation model may be a model obtained by secondary packaging or training based on a generative model. For example, the preset script generation model may be a model obtained by secondary training further on script generation function of a generative model. The embodiment of the present disclosure does not limit the specific type of the generative model.

Video production style may be characteristic that distinguishes one video type from other video types. The video style may be embodied specifically by the difference of video production outlines corresponding to different video types, and/or the difference of video production elements corresponding to different video types. A keyword of input content may be words that may reflect the central concept of the input content. The embodiment does not limit the number of keywords. Alternatively, the keyword of the input content may be words obtained by keyword extraction to the input content.

In the present embodiment, the input content input by the video creator into the video processing apparatus may include a video production theme or a video production copywriting. After receiving the input content, the video processing apparatus inputs the input content into a preset script generation model, which identifies the type of the input content and outputs the video type corresponding to the input content. As an example, if the input content includes a video production theme, and the input content includes a parent-child guide to scenic spot A, the identified video type may include a travelling type; if the input content includes store exploration and photography skills for store B, the identified video type may be a food type.

In the present embodiment, there may be preset a type-style correspondence relationship between the video type and the video production style. After determining the video type according to the input content, the video processing apparatus matches the video type with the type-style correspondence relationship, determines a successfully matched video production style and extracts keywords in the input content, inputs the successfully matched video production style and keywords into a preset script generation model, which determines corresponding video production outline, shooting information, copywriting content, etc., according to the successfully matched video production style and keywords and integrates the video production outline, shooting information, copywriting content, etc. into an initial video script, and then, outputs the initial video script.

In the above solution, the video production style and keywords are determined based on the input content, and then the initial video script is generated based on the video production style and keywords, such that the style and text content of the generated initial video script may better match the input content, and may better meet the video production requirements of video creator. In addition, the video creator enters the input content once and can generate the initial video script, which reduces expertise requirements for the video creator to interact with model.

In some embodiments of the present disclosure, if the input content includes video production copywriting, after identifying the video type corresponding to the input content using a preset script generation model, the video processing apparatus may generate the initial video script using the preset script generation model based on the video production style corresponding to the video type and the input content.

S130. Displaying the initial video script on a first page.

The first page may be a display page for the video script. The first page may come from a variety of sources, which is not limited in the embodiment. For example, the first page may be a page in a video processing application (APP), or the first page may be a page in a video processing tool. The video processing application may implement the display of the first page by calling a port of the video processing tool. The video processing application may be an application that implements all or part of the steps of the video processing method; the video processing tool may be a functional plug-in that implements all or part of the steps of the video processing method, and the video processing tool may be integrated into the application, or the video processing tool may be called by the application in the form of a port.

In the embodiment of the present disclosure, after the initial video script is determined, the initial video script is displayed on the first page, so that the video creator can perform processes such as modifying the script or create a video based on the initial video script.

In some embodiments of the present disclosure, displaying the initial video script on a first page comprises: displaying the initial video script in a target structured style on the first page.

The target structured style may be an organized and programmatic display style. The present embodiment does not limit the target structured style. For example, the target structured style may be any one of a table style, a multi-level heading style, or a structure tree styles.

In the table style, shooting information and copywriting content corresponding to an outline item in a video production outline may be located in the same row in the table. Shooting information of different outline items may be located in the same column in the table. The copywriting content of different outline items may be located in the same column in the table.

In the multi-level heading style, different levels of headings may be set according to a video production outline and its corresponding shooting information and copywriting content. As an example, multi-level heading may include first-level headings, second-level headings, and third-level headings. The first-level heading may be each outline item included in the video production outline, the second-level heading may be copywriting content corresponding to each outline item, and the third-level heading may be shooting information corresponding to each outline item.

In the structure tree style, corresponding structure tree nodes may be set according to a video production outline and its corresponding shooting information and copywriting content. As an example, a structure tree may include a root node, child nodes, and grandchild nodes. The root node may be each outline item included in the video production outline, the child nodes may be copywriting content corresponding to each outline item, and the grandchild nodes may be shooting information corresponding to each outline item.

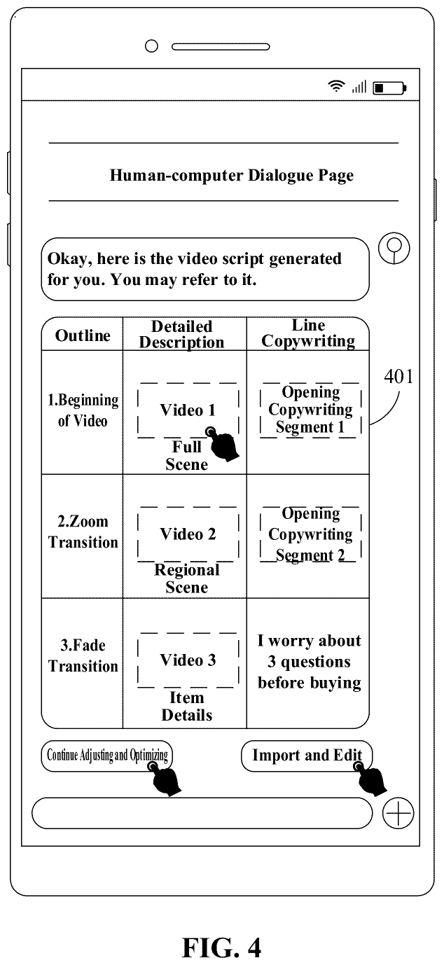

In an embodiment of the present disclosure, after an initial video script is determined, on a first page for interacting with a video creator, the style of the initial video script is converted into a target structured style, and the initial video script of the target structured style is displayed. FIG. 4 is a schematic diagram of an initial video script displayed in a target structured style provided by an embodiment of the present disclosure. As shown in FIG. 4, what is displayed in the dialog box 401 is an initial video script in a target structured style.

In the above solution, a video script may be displayed to users in a more organized manner based on a target structured style, so that the users can more efficiently understand information represented by the video script.

In some embodiments of the present disclosure, displaying an initial video script in a target structured style comprises: displaying the initial video script in a table style on a first page, and one table item displaying video production elements corresponding to one video production outline, and each of the video production elements being displayed hierarchically according to preset priorities.

One video production outline may be understood as an outline item in a video production outline. In the table style, video production elements corresponding to each outline item in the video production outline in chronological order may be displayed in row order from top to bottom. Shooting information and copywriting content corresponding to different outline items are located in the same columns in the table style. A table item may be a horizontal bar in the table style, and the table item may be understood as a row in the table style.

In the present embodiment, the target structure style is a table style, and the video processing apparatus acquires the video production outline in the initial video script, and determines the display rows of the outline items in the table style according to the order of each outline item in the video production outline. The outline items that are earlier in time sequence have higher display rows. Shooting information and copywriting content of different outline items are displayed in the same column in the table style. Then overall stage information is displayed in a table style.

As shown in FIG. 4, each outline item in the video production outline is displayed under the outline column. The shooting information of different outline items is displayed under the detailed description column; the copywriting content of different outline items is displayed under the line copywriting column. And the outline items are displayed in chronological order from top to bottom in the table style. It should be noted that the first page in FIG. 4 has a plurality of controls that may be triggered, and triggering effects of the plurality of controls will be described later.

In the above solution, the initial video script may be displayed in a more organized manner in a table style, and information corresponding to one outline item in the video production outline is displayed in the same table item, which is more in line with the video creator's habit of viewing video scripts. Thus, the display effect of the initial video script is further improved.

The video processing method provided by the above embodiments of the present disclosure enables video creators to edit input content according to their own video production requirements in a scenario where video scripts are automatically generated. A video creator only needs to input the input content once, and then a video processing apparatus can generate a video script according to the input content. The video script includes a video production outline and its corresponding video production elements. The video production elements include copywriting content and at least one of a shooting location, a shooting angle, a shooting prop and a shooting sample material. The video script includes a wide variety of information, which can comprehensively assist video creators in video creation, reduce the requirement for video creators to have relevant professional knowledge in editing scripts, save time and energy for video creators, improve the efficiency of video script generation, and reduce the cost of video creation, thereby can efficiently assist video creators in video creation.

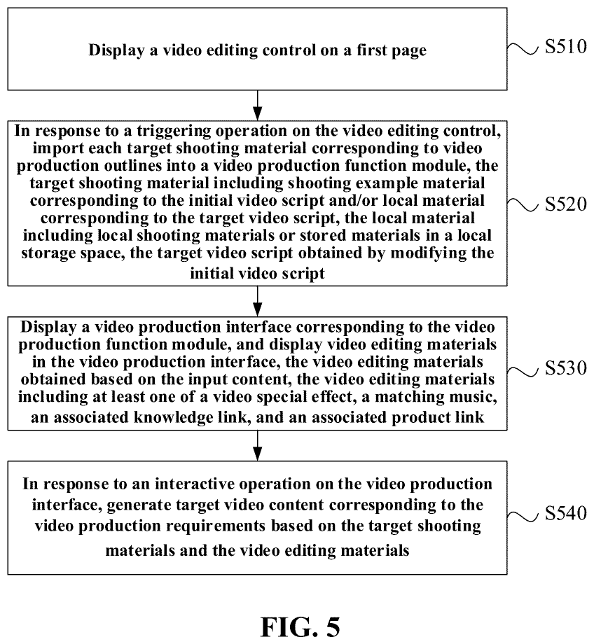

FIG. 5 is a schematic flowchart of generating target video content provided by an embodiment of the present disclosure. As shown in FIG. 5, in some embodiments of the present disclosure, after an initial video script is displayed in a target structured style on a first page, the video processing method further comprises the followings.

S510. Displaying a video editing control on the first page.

The video editing control may be a control that instructs a target shooting material to be imported into a tool or application with a video editing function, and the video editing control may be an import and edit virtual button in FIG. 4.

In the embodiment, the video editing control is displayed on the first page, and a video creator may trigger the video editing control via voice, touch, etc.

S520. In response to a triggering operation on the video editing control, importing each target shooting material corresponding to a video production outline into a video production function module, wherein the target shooting material includes shooting example material corresponding to the initial video script and/or local material corresponding to the target video script, the local material includes local shooting materials or stored materials in local storage space, and the target video script is obtained by modifying the initial video script.

The triggering operation may cause the function corresponding to the control to perform an operation. There are many ways of triggering the operation, which are not limited in the embodiment. For example, the triggering operation may include any one or more of voice control, touch, and mouse click.

The video production function module may be a module with video editing and production functions. The video production function module can come from a variety of sources. The present embodiment does not limit the source of the video production function module. For example, the video production function module may be a tool included in a video processing application itself; or the video production function module may be a video production application, which may be called through its own reserved port.

The target shooting material may be a video clip corresponding to the shooting information. The target video script may be a final video script generated by combining an automatically generated initial video script and manual editing by the video creator. The local material may be a video clip manually determined by the video creator. The local shooting material may be a video clip obtained by shooting by the video creator in the process of manually determining local materials. The stored material may be a video clip obtained in a selected way by the video creator in the process of manually determining local materials.

In the present embodiment, the video processing apparatus determines target shooting materials corresponding to each outline item in the video production outline in response to the triggering operation on the video editing control, and imports each target shooting material into the predetermined video production function module.

S530. Displaying a video production interface corresponding to the video production function module, and displaying video editing materials in the video production interface, wherein the video editing materials are obtained based on the input content; the video editing materials include at least one of a video special effect, a matching music, an associated knowledge link and an associated product link.

The video production interface may be a display interface for interacting with the video creator to complete video production. The video editing materials may be materials used to enrich the final generated target video content display effects.

The video special effects may be virtual special effects, which include but are not limited to one or more of filters, virtual stickers, and portrait beautification. The matching music may be audio resources that match the target shooting material. The associated knowledge links may be hyperlinks to knowledge texts that are associated with the target shooting materials. There are many types of associated knowledge, which are not limited in the embodiment. For example, the associated knowledge may be an encyclopedia introduction of text keyword of the target shooting materials. The associated product links may be hyperlinks to products that are associated with the target shooting materials. There are many types of associated products, which are not limited in the embodiment. For example, the associated products may be products corresponding to the text keyword of the target shooting materials.

In the embodiment of the present disclosure, the video editing material corresponding to the target shooting material is determined through the video production function module. After jumping from the first page to a video production page of the video production function module, the video editing material is displayed on the video production page for the video creator to filter and add video editing materials according to their own needs and determine display time and display method of each video editing material.

S540. Generating target video content corresponding to the video production requirements based on the target shooting materials and the video editing materials in response to an interactive operation on the video production interface.

The interactive operation may be an operation of interacting with the video production page to generate the target video content. The interactive operation includes but is not limited to: a video clip operation on the target shooting materials and/or a material adjustment operation on the video editing materials. The present embodiment does not limit the interactive operation method. For example, the interactive operation method may include voice control, touch control, etc. The target video content may be understood as video content obtained after processing by the video production function module and that meets the video production requirements of the video creator.

In the present embodiment, in the video production page, video creators may interact with the video production interface according to their own video production requirements to further adjust the target shooting materials and/or video editing materials. The video production function module responds to the interactive operation to generate target video content that meets the video production requirements of video creators.

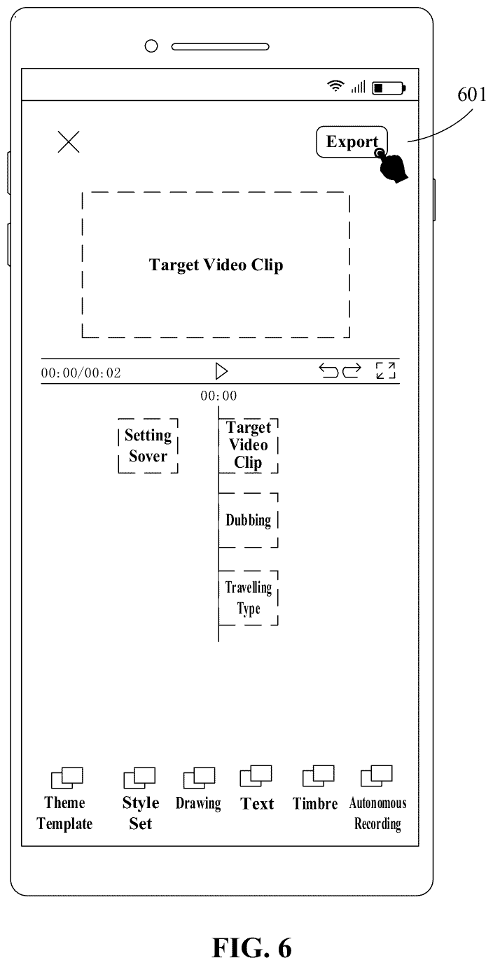

As an example, as shown in FIG. 4, the video editing control may be an import and edit virtual button, and a video creator may click the import and edit virtual button. In response to the click operation of the import and edit virtual button, it is jumped to a video production interface 601 as shown in FIG. 6. In this video production page, the video creator may perform one or more interactive operations of editing target shooting material operation, setting video cover operation, adjusting dubbing operation, and adjusting video production style operation (in FIG. 6, the original video production style is travel type). In addition, the video creator may also perform one or more interactive operations of theme template adjustment operation, style set adjustment operation, video frame drawing operation, text addition operation, tone setting operation, and independent recording and dubbing operation. After completing interactive operations of video production, the video creator may click an export button to export the generated target video content.

In the above solution, video creators may further process target shooting materials according to their own video production requirements, adding manual processing steps by the video creators on the basis of automatic generation. On the basis of saving the video production effort of the video creators, final generated target video content may be more in line with video production requirements of the video creators.

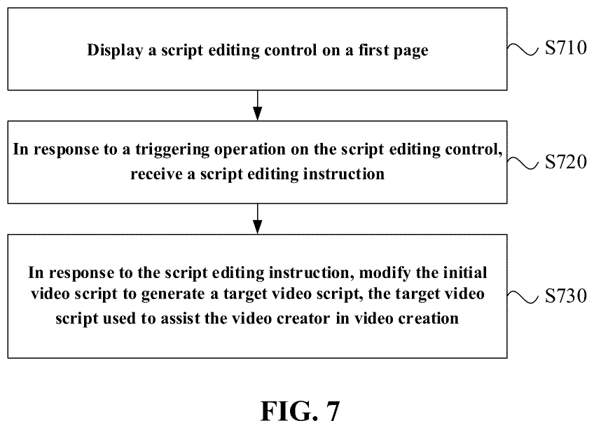

FIG. 7 is a schematic flowchart of another video processing method provided by an embodiment of the present disclosure. As shown in FIG. 7, after an initial video script is displayed in a target structured style on a first page, the video processing method further comprises the followings.

S710. Displaying a script editing control on the first page.

The script editing control may be a control for triggering editing of a video script. The present embodiment does not limit the style of the script editing control. For example, the script editing control may be a virtual button displayed on the first page, or the script editing control may be text or pictures that may be triggered in the initial video script. As an example, as shown in FIG. 4, the script editing control may continue adjusting and optimizing virtual button.

In the present embodiment, a script editing control in the style of a virtual button may be set on the first page, or text and/or picture in the initial video script may be added with a trigger function to obtain a script editing control and display the script editing control.

S720. Receiving a script editing instruction in response to a triggering operation on the script editing control.

The script editing instruction may be an instruction that instructs to modify the initial script video. The script editing instruction has multiple roles, which are not limited in the embodiment. For example, the script editing instruction may include one or more of an order adjustment instruction between outline items in the video production outline, an inserting instruction for new outline items and their corresponding video production elements, a deleting instruction for outline items and their corresponding video production elements, a content modification instruction for shooting information and a content modification instruction for copywriting content.

In the present embodiment, the video creator may trigger the script editing control via approaches such as voice operation, touch operation, etc. The video processing apparatus enters a script editing page in response to a triggering operation on the script editing control. The video creator may edit the initial video script on the script editing page and generate corresponding script editing instruction, which is received by the video processing apparatus.

S730. Modifying the initial video script in response to the script editing instruction, to generate a target video script; the target video script is used to assist the video creator in video creation.

The target video script may be a final video script generated by combining an automatically generated initial video script and manual editing by the video creator.

In the present embodiment, the video processing apparatus responds to the script editing instruction and modifies the initial video script according to the script editing instruction. The modification includes but is not limited to: sequence adjustment between outline items in the video production outline, insertion of new outline items and their corresponding video production elements, deletion of outline items and their corresponding video production elements, content modification of shooting information, and content modification of copywriting content. After the video processing apparatus completes the modification corresponding to the script editing instruction, the final target video script is obtained.

In the above solution, the initial video script is edited, and the adjustment method based on the video script is more organized. Moreover, the video may be adjusted more efficiently in the dimension of the video script compared with the method of first generating a video and then adjusting the video.

In some embodiments of the present disclosure, in response to a script editing instruction, an initial video script is modified to generate a target video script. There are many ways for generating the target video script, which are not limited in the embodiment. Examples are as follows.

In an alternative implementation, in response to a global modification operation on video production elements corresponding to any video production outline, an initial video script is modified to generate a target video script; wherein the global modification operation includes a deletion operation, a sequence adjustment operation or an addition operation.

Any video production outline may be understood as any outline item in a video production outline. The global modification operation may be a modification operation with a video production element as a base unit, which may also be understood as a global modification operation on table items in a table style. The deletion operation may be an operation of deleting the entire outline item and its corresponding video production elements. The sequence adjustment operation may be an operation to adjust orders between multiple outline items and their corresponding video production elements as a whole. The addition operation may be an operation of adding a new outline item and its corresponding video production elements, through which a new outline item including specific content and its corresponding video production elements may be added, through which a blank outline item that needs to be filled with content and its corresponding video production elements may also be added.

In the present embodiment, after a video creator performs a triggering operation on the script editing control, the outline item and its corresponding video production elements may be performed modification operation as a whole. In response to the global modification operation, the video processing apparatus modifies the initial video script according to a global modification instruction corresponding to the global modification operation, so that script modification may be performed efficiently to obtain the target video script.

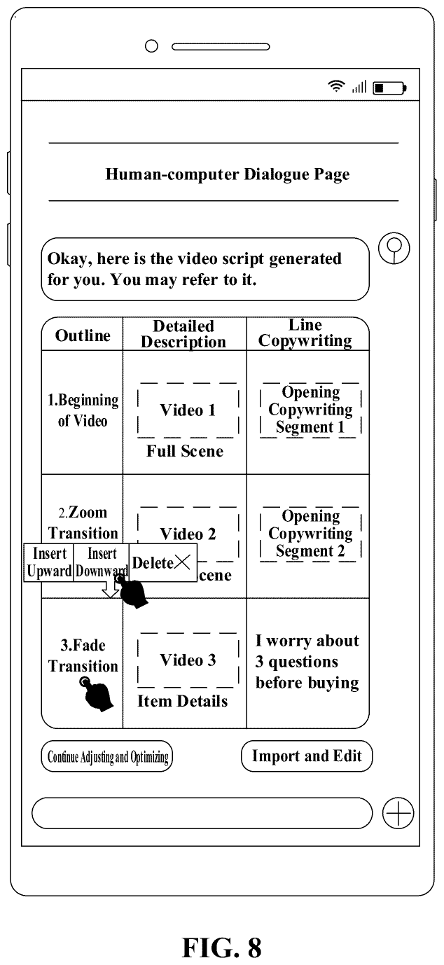

As an example, after a video creator clicks continue adjusting and optimizing control in FIG. 4, if the video creator wants to make a global adjustment to video production elements whose outline item is fade transition, the video creator may continue to trigger an interface area where the fade transition is located, as shown in FIG. 8. In response to a triggering operation on an interface area where fade transition is located, the video processing apparatus displays a global operation control in an associated area of the fade transition. The global operation control includes one or more of an upward inserting sub-control, a downward inserting sub-control, and a deleting sub-control. Wherein, the upward inserting sub-control is used to insert a new row above and adjacent to the fade transition, the downward inserting sub-control is used to insert a new row below and adjacent to the fade transition, and the deleting sub-control is used to delete the fade transition and its corresponding video production elements.

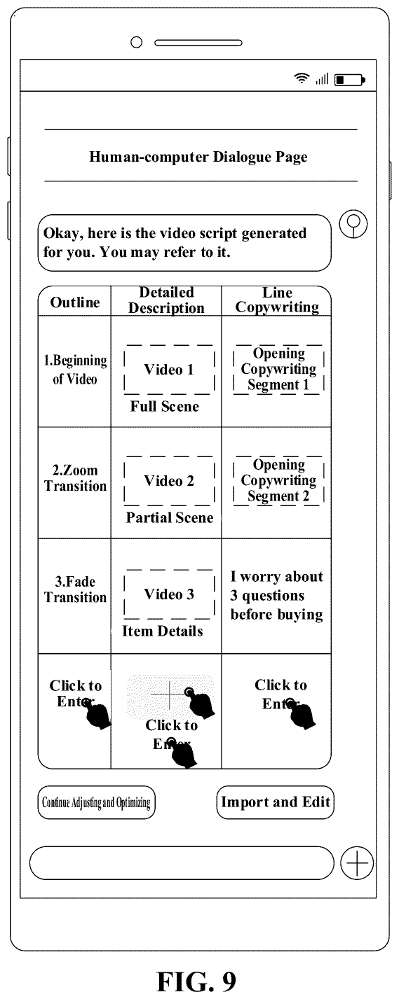

Take the video creator triggering the downward inserting sub-control as an example. As shown in FIG. 9, a new blank row is inserted below the fade transition, and the video creator may perform a triggering operation on an area corresponding to an outline item, shooting information, and copywriting content in the blank row according to own video production requirements, and then perform one or more of corresponding text input operation, picture insertion operation, and video insertion operation.

In another alternative implementation, in response to a local modification operation on any one of video production elements corresponding to any video production outline, an initial video script is modified based on input content corresponding to the local modification operation, to generate a target video script.

The local modification operation may be a modification operation on one or more pieces of information included in the video production elements, which may also be understood as a modification operation on the interior of table items in a table style. The local modification operation includes but is not limited to modification operations on one or more of shooting location, shooting angle, shooting props, shooting sample materials, and copywriting content.

In the present embodiment, a video creator may perform a local modification operation on the video production elements after performing a triggering operation on a script editing control. In response to the local modification operation, a video processing apparatus modifies the video production elements of the initial video script according to a local modification instruction corresponding to the local modification operation to obtain the target video script.

In the above solution, the global modification operation may modify the initial video script with the entire video production elements as a base unit, so that the script modification may be performed efficiently to obtain the target video script. Through local modification operations, the initial video script is fine-tuned, and adjustment granularity of the video script was refined.

In some embodiments of the present disclosure, in response to a local modification operation on any of the video production elements corresponding to any video production outline, modifying an initial video script based on input content corresponding to the local modification operation to generate the target video script comprises: in response to a triggering operation on a shooting sample material, displaying a material replacement control in a first area on a first page; in response to a triggering operation on the material replacement control, displaying a shooting control in a second area on the first page; in response to a triggering operation on the shooting control, displaying a shooting preview screen at a shooting angle corresponding to the triggered shooting sample material; in response to a shooting operation on the shooting preview screen, generating a local shooting material, and replacing the triggered shooting sample material with the local shooting material, to generate the target video script.

The first area may be any area on the first page, which is not limited in the embodiment. For example, the first area may be located in the upper half of the first page. The material replacement control may be a control used to replace a shooting sample material. Text displayed on the material replacement control may be deletion text characterizing the deletion of a shooting sample material or replacement text characterizing the replacement of a shooting sample material.

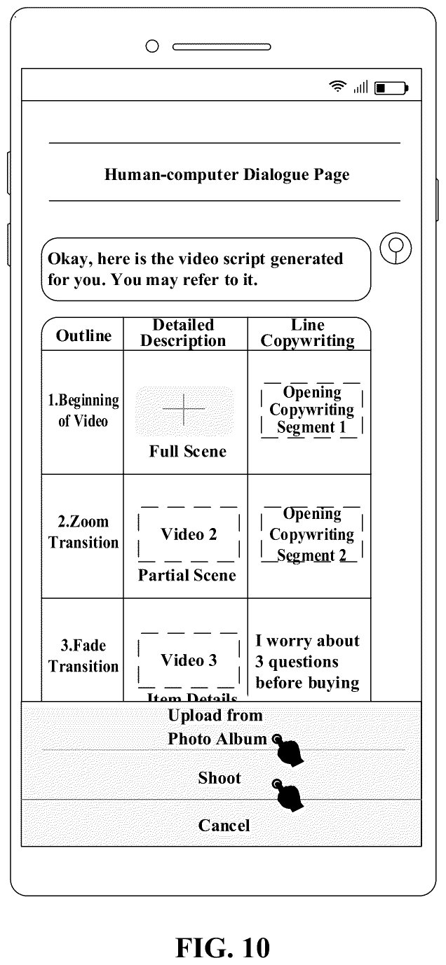

The second area may be any area on the first page. The second area may overlap with the first area, or the second area may not overlap with the first area. The shooting control may be a control used for shooting new shooting materials, which is not limited in the embodiment. For example, the shooting control may be the shooting button in FIG. 10.

The preview shooting screen may be a real-time preview screen through lens framing. The shooting operation may be an operation that instructs to shoot a shooting material, the method of which is not limited in the embodiment. For example, the shooting operation may be a voice control method, a touch control method, etc. The local shooting material may be a newly shot video clip by the video creator. The target video script may be a video script obtained after updating the shooting material.

In the present embodiment, the video creator may perform a triggering operation on a shooting sample material in any stage of information displayed on the first page through a voice control operation, touch operation, etc. In response to the triggering operation on the shooting sample material, the video processing apparatus displays a segment replacement control in a first area on the first page. There are multiple types of the segment replacement control, which is not limited in the embodiment. In an alternative implementation, the material replacement control may be a deletion control characterizing the deletion of a shooting sample material. The video creator triggers the deletion control, and the video processing apparatus deletes the shooting sample material in response to the triggering operation on the deletion control and displays an addition control characterizing the addition of a new video material. The video creator may trigger the addition control, and the video processing apparatus displays a shooting control in a second area on the first page in response to a triggering operation on the addition control.

In another alternative implementation, the material replacement control may be a replacement control characterizing the replacement of a shooting sample material. The video creator triggers the replacement control, and the video processing apparatus deletes the shooting sample material in response to a triggering operation on the replacement control and displays a shooting control in a second area on the first page.

After displaying the shooting control, the video creator may trigger the shooting control through a voice control operation, touch operation, etc. In response to a triggering operation on the shooting control, the video processing apparatus acquires a shooting angle in the shooting information, and performs image processing on viewfinder screen of the lens through the shooting angle to obtain a shooting preview screen. Furthermore, the shooting preview screen is displayed so that the video creator can know current live view screen effect. The video creator may perform a shooting operation on the shooting preview screen during watching the shooting preview screen. In response to a shooting operation on the shooting preview screen, the video processing apparatus records a video clip corresponding to the shooting preview screen and generates a local shooting material.

After determining the local shooting material, the video processing apparatus replaces the shooting sample material with the local shooting material to update the triggered video production element. The updated video production element and other untriggered video production elements constitute video production elements in the target video script.

In the above solution, the video creator may replace automatically determined shooting sample materials and shoot new shooting materials based on automatically determined shooting angles to obtain local shooting materials. Replacing shooting sample materials with local shooting materials can realize customized setting for shooting materials, and because shooting of the local shooting material is based on automatically determined shooting angle, the new local shooting material is consistent with the style of other materials, thus improving the display effect of subsequent video content generated based on various materials.

In some embodiments of the present disclosure, after displaying a material replacement control in a first area on a first page in response to a triggering operation on a shooting sample material, the video processing method further comprises: in response to a triggering operation on the material replacement control, displaying a material selection control in a third area on the first page; in response to a triggering operation on the material selection control, displaying a second page, and displaying each stored material in a local storage space on the second page; and in response to a selection operation on any stored material on the second page, replacing the triggered shooting sample material with the selected stored material, to generate a target video script.

The third area may be any area on the first page. The third area may overlap with the first area and/or the second area, or the third area may not overlap with the first area and the second area. The material selection control may be a control used for select an existing material, which is not limited in the embodiment. For example, the material selection control may be a virtual button for uploading from a photo album in FIG. 10. The second page may be a display page for video content local to an electronic device. The stored materials may be materials stored locally on an electronic device.

In the present embodiment, after deleting a candidate video clip, the video processing apparatus displays the material selection control in the third area on the first page. The video creator may trigger the material selection control through voice control operation, touch operation, etc. The video processing apparatus jumps from the first page to the second page in response to a triggering operation on the material selection control, and displays on the second page a preview of locally stored materials on an electronic device. The video creator may realize the selection operation on the stored materials by triggering the preview of the stored materials according to their own needs. In response to the selection operation of the stored material, the video processing apparatus determines the selected stored material, and replaces the shooting example material with the selected stored material, so as to realize the update of the triggered video production element. The updated video production element and other untriggered video production elements constitute video production elements in the target video script.

In the above solution, the video creator may automatically determine the shooting sample materials based on the locally stored video materials, and obtain the target video script, realizing customized setting for materials.

The following is an embodiment of a video processing apparatus provided by an embodiment of the present invention. This apparatus and the video processing method of the above embodiments belong to the same inventive concept. Details that are not described in detail in the embodiments of the video processing apparatus may be referred to the above embodiments of the video processing methods.

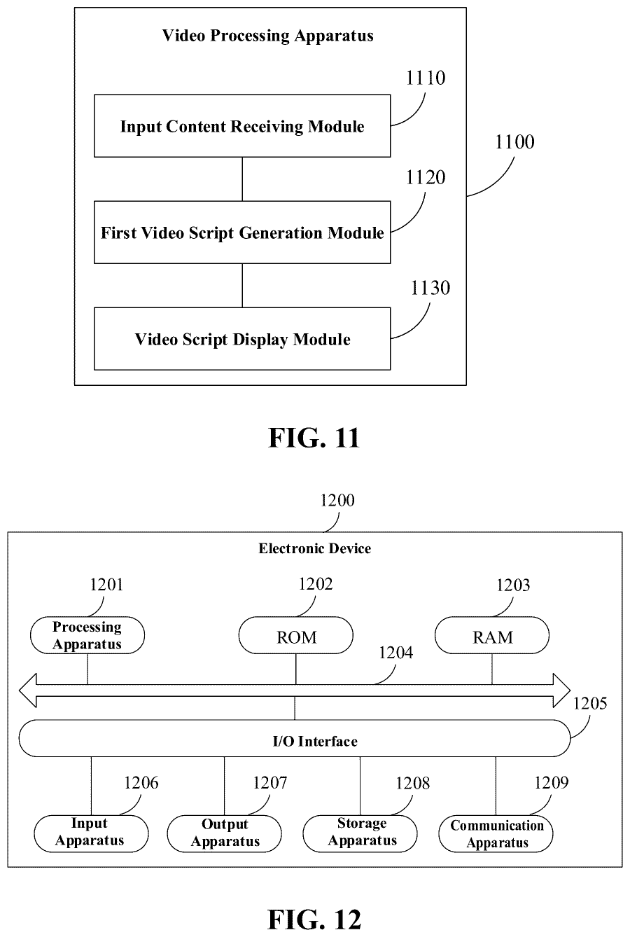

FIG. 11 shows a schematic structural diagram of a video processing apparatus provided by an embodiment of the present disclosure. As shown in FIG. 11, the video processing apparatus 1100 may include:
an input content receiving module 1110, configured to receive input content, wherein the input content is used for characterizing video production requirements;
a first video script generation module 1120, configured to generate an initial video script based on the input content, wherein the initial video script includes video production outlines and video production elements corresponding to the video production outlines, the video production elements including shooting information and copywriting content corresponding to the video production outlines, the shooting information including at least one of a shooting location, a shooting angle, a shooting prop and a shooting sample material; the initial video script is used to assist a video creator in video creation; and
a video script display module 1130, configured to display the initial video script on a first page.

In some embodiments, the first video script generation module 1120 is configured to: generate an initial video script based on a video type corresponding to the input content, wherein the video production outline and video production elements in the initial video script have a correspondence relationship with the video type.

In some embodiments, the first video script generation module 1120 is configured to:
identify a video type corresponding to input content using a preset script generation model; and
generate an initial video script using the preset script generation model based on a video production style corresponding to the video type and a keyword of the input content; wherein, the video production style is used for characterizing correspondence relationship.

In some embodiments, the video script display module 1130 is configured to: display the initial video script in a target structured style on the first page.

In some embodiments, the video script display module 1130 is configured to: display the initial video script in a table style on a first page, and one table item displaying video production elements corresponding to one video production outline, and each of the video production elements being displayed hierarchically according to preset priorities.

In some embodiments, the video processing apparatus 1100 further comprises:
a video editing control display module, configured to display a video editing control on the first page after displaying the initial video script on the first page;
a material import module, configured to import each target shooting material corresponding to the video production outline into a video production function module in response to a triggering operation on the video editing control, wherein the target shooting material includes the shooting example material corresponding to the initial video script and/or local material corresponding to a target video script, the local material including local shooting materials or stored materials in a local storage space; the target video script is obtained by modifying the initial video script;
a material display module, configured to display a video production interface corresponding to the video production function module, and to display video editing materials in the video production interface, wherein the video editing materials are obtained based on the input content, and the video editing materials include at least one of a video special effect, a matching music, an associated knowledge link and an associated product link; and
a video content generation module, configured to generate target video content corresponding to the video production requirements based on the target shooting materials and the video editing materials in response to an interactive operation on the video production interface.

In some embodiments, the video processing apparatus 1100 further comprises:
a script editing control display module, configured to display a script editing control on the first page after displaying the initial video script on the first page;
an instruction receiving module, configured to receive a script editing instruction in response to a triggering operation on the script editing control; and
a script modification module, configured to modify the initial video script in response to the script editing instruction to generate a target video script; the target video script is used to assist a video creator in video creation.

In some embodiments, the script modification module comprises:
a global modification unit, configured to modify the initial video script to generate the target video script in response to a global modification operation on the video production elements corresponding to any of the video production outlines, wherein the global modification operation includes a deletion operation, a sequence adjustment operation, or an addition operation; or,
a local modification unit, configured to, in response to a local modification operation on any of the video production elements corresponding to any of the video production outlines, modify the initial video script based on input content corresponding to the local modification operation, to generate the target video script.

In some embodiments, the local modification unit is configured to:
in response to a triggering operation on the shooting sample material, display a material replacement control in a first area on the first page;
in response to a triggering operation on the material replacement control, display a shooting control in a second area on the first page;
in response to a triggering operation on the shooting control, display a shooting preview screen at the shooting angle corresponding to the triggered shooting sample material; and
in response to a shooting operation on the shooting preview screen, generate a local shooting material, and replace the triggered shooting sample material with the local shooting material to generate the target video script.

In some embodiments, the local modification unit is further configured to:
after displaying the material replacement control in a first area on the first page in response to a triggering operation on the shooting sample material, displaying a material selection control in a third area on the first page in response to a triggering operation on the material replacement control;
in response to a triggering operation on the material selection control, display a second page, and display each stored material in a local storage space on the second page; and
in response to a selection operation on any of the stored materials on the second page, replace the triggered shooting example material with the selected stored material to generate the target video script.

The video processing apparatus provided by the embodiments of the present invention may execute the video processing methods provided by any embodiment of the present invention, and has functional modules and beneficial effects corresponding to executing the methods.

It should be noted that, in the above embodiments of the video processing apparatus, various modules and units included are only divided according to functional logic, but are not limited to the above divisions, as long as corresponding functions can be realized; in addition, the specific names of respective functional modules/units are only for the convenience of distinguishing each other and are not used to limit the scope of protection of the present disclosure.

An embodiment of the present disclosure further provide an electronic device, which may include a processor and a memory, and the memory may be configured to store executable instructions. Wherein, the processor may be configured to read the executable instructions from the memory and execute the executable instructions to implement the video processing methods in the above embodiments.

FIG. 12 shows a schematic structural diagram of an electronic device provided by an embodiment of the present disclosure.

As shown in FIG. 12, the electronic device 1200 may include a processing apparatus 1201 (e.g., a central processing unit, a graphics processor, etc.), which may execute various appropriate actions and processes according to a program stored in a read-only memory (ROM) 1202 or a program loaded from a storage apparatus 1208 into a random-access memory (RAM) 1203. In the RAM 1203, various programs and data required for operations of the electronic device 1200 are also stored. The processing apparatus 1201, ROM 1202 and RAM 1203 are connected to each other via a bus 1204. An input/output (I/O) interface 1205 is also connected to bus 1204.

Generally, the following apparatus may be connected to the I/O interface 1205: an input apparatus 1206 including, for example, a touch screen, a touch pad, a keyboard, a mouse, a camera, a microphone, an accelerometer, a gyroscope, etc.; an output apparatus 1207 including, for example, a liquid crystal display (LCD), a speaker, a vibrator, etc.; a storage apparatus 1208 including, for example, a magnetic tape, a hard disk, etc.; and a communication apparatus 1209. The communication apparatus 1209 may allow the electronic device 1200 to perform wireless or wired communication with other devices to exchange data.

It should be noted that the electronic device 1200 shown in FIG. 12 is only an example and should not bring any limitations to the functions and scope of use of the embodiments of the present disclosure. That is, although FIG. 12 illustrates the electronic device 1200 having various apparatus, it should be understood that it is not required to implement or provide all of the illustrated apparatus. More or fewer apparatus may be implemented or provided alternatively.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, and the computer program contains program code for executing the method illustrated in the flowchart. In such embodiments, the computer program may be downloaded and installed from the network via the communication apparatus 1209, or installed from the storage apparatus 1208, or installed from the ROM 1202. When the computer program is executed by the processing apparatus 1201, the above functions defined in the video processing method of any embodiment of the present disclosure are executed.

An embodiment of the present disclosure further provides a computer-readable storage medium having a computer program stored thereon, which, when executed by a processor, causes the processor to implement the video processing method in any embodiment of the present disclosure.

It should be noted that above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program, and the program may be used by or in combination with an instruction execution system, apparatus, or device. In the present disclosure, a computer-readable signal medium may include a data signal propagated in a baseband or as a part of a carrier wave, in which a computer-readable program code is carried. This propagated data signal may take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program for use by or in combination with the instruction execution system, apparatus, or device. The program code contained on the computer-readable medium may be transmitted by any suitable medium, including but not limited to: wire, optical cable, RF (Radio Frequency), etc., or any suitable combination thereof.

In some embodiments, the client and server may communicate with any currently known or future developed network protocol such as HTTP, and may interconnect with digital data communication (for example, communication network) in any form or medium. Examples of communication networks include local area networks (“LAN”), wide area networks (“WAN”), international network (for example, the Internet), and end-to-end networks (for example, ad hoc end-to-end networks), as well as any currently known or future developed networks.

The above computer-readable medium may be included in the above electronic device; or it may exist alone without being assembled into the electronic device.

The computer-readable medium carries one or more programs, which, when executed by the electronic device, cause the electronic device to perform the steps of the video processing method described in any embodiment of the present disclosure.

In the embodiments of the present disclosure, computer program code for performing the operations of the present disclosure may be written in one or more programming languages or a combination thereof. The above programming languages include but are not limited to object-oriented programming languages such as Java, Smalltalk, C++, and include conventional procedural programming languages such as “C” language or similar programming languages. The program code may be executed entirely on a user's computer, partly executed on a user's computer, executed as an independent software package, partly executed on a user's computer and partly executed on a remote computer, or entirely executed on a remote computer or server. In the case of involving a remote computer, the remote computer may be connected to a user's computer through any kind of network, including a local area network (LAN) or a wide area network (WAN), or it may be connected to an external computer (for example, connected by using Internet provided by an Internet service provider).

The flowcharts and block diagrams in the accompanying drawings illustrate possible architecture, function, and operation implementations of a device, method, and computer program product according to various embodiments of the present disclosure. In this regard, each block in a flowchart or block diagram may represent a module, program segment, or part of code, which contains one or more executable instructions for realizing specified logic functions. It should also be noted that, in some alternative implementations, functions marked in a block may also occur in a different order than the order marked in the drawings. For example, two blocks shown in succession may actually be executed substantially in parallel, and they may sometimes be executed in the reverse order, depending on functions involved. It should also be noted that each block in a block diagram and/or flowchart, and the combination of blocks in a block diagram and/or flowchart, may be implemented by a dedicated hardware-based system that performs the specified functions or operations, or it may be implemented by a combination of dedicated hardware and computer instructions.

The functions described herein above may be performed at least in part by one or more hardware logic components. For example, without limitation, exemplary types of hardware logic components that may be used include: Field Programmable Gate Array (FPGA), Application Specific Integrated Circuit (ASIC), Application Specific Standard Product (ASSP), System on Chip (SOC), Complex Programmable Logical device (CPLD) and so on.

In the context of the present disclosure, a machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage media may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an explanation to the technical principles applied. Those skilled in the art should understand that the scope of disclosure involved in this disclosure is not limited to technical solutions formed by specific combination of above technical features, and should also cover other technical solutions formed by arbitrarily combining above technical features or equivalent features thereof without departing from above disclosed concept. For example, those technical solutions formed by exchanging of above features and technical features disclosed in the present disclosure (but not limited to) having similar functions with each other.

In addition, although various operations are depicted in a specific order, this should not be understood as requiring these operations to be performed in the specific order shown or performed in a sequential order. Under certain circumstances, multitasking and parallel processing may be advantageous. Likewise, although several specific implementation details are included in above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. Rather, the specific features and actions described above are merely exemplary forms of implementing the claims.

1. A video processing method, comprising:
receiving input content, the input content used for characterizing video production requirements;
generating an initial video script based on the input content, the initial video script including a video production outlines and video production elements corresponding to the video production outlines, the video production elements including shooting information and copywriting content corresponding to the video production outline, the shooting information including at least one of a shooting location, a shooting angle, a shooting prop and a shooting sample material, the initial video script being used to assist a video creator in video creation; and
displaying the initial video script on a first page.

2. The method according to claim 1, wherein the generating an initial video script based on the input content comprises:
generating the initial video script based on a video type corresponding to the input content, the video production outline and the video production elements in the initial video script have a correspondence relationship with the video type.

3. The method according to claim 2, wherein the generating the initial video script based on a video type corresponding to the input content comprises:
identifying the video type corresponding to the input content using a preset script generation model;
generating the initial video script using the preset script generation model based on a video production style corresponding to the video type and a keyword of the input content, wherein the video production style is used for characterizing the correspondence relationship.

4. The method according to claim 1, wherein the displaying the initial video script on a first page comprises:
displaying the initial video script in a target structured style on the first page.

5. The method according to claim 4, wherein the displaying the initial video script in a target structured style on the first page comprises:
displaying the initial video script in a table style on the first page, one table item displaying the video production elements corresponding to one of the video production outlines, each of the video production elements being displayed hierarchically according to preset priorities.

6. The method according to claim 1, wherein after the displaying the initial video script on a first page, the method further comprises:
displaying a video editing control on the first page;
in response to a triggering operation on the video editing control, importing each target shooting material corresponding to the video production outlines into a video production function module, the target shooting materials including the shooting example material corresponding to the initial video script and/or a local material corresponding to a target video script, the local material including local shooting materials or stored materials in a local storage space, the target video script obtained by modifying the initial video script;
displaying a video production interface corresponding to the video production function module, and displaying video editing materials in the video production interface, the video editing materials obtained based on the input content, the video editing materials including at least one of a video special effect, a matching music, an associated knowledge link and an associated product link; and
in response to an interactive operation on the video production interface, generating target video content corresponding to the video production requirements based on the target shooting materials and the video editing materials.

7. The method according to claim 1, wherein after the displaying the initial video script on a first page, the method further comprises:
displaying a script editing control on the first page;
receiving a script editing instruction in response to a triggering operation on the script editing control;
modifying the initial video script, in response to the script editing instruction, to generate a target video script, the target video script used to assist a video creator in video creation.

8. The method according to claim 7, wherein the modifying the initial video script in response to the script editing instruction to generate a target video script comprises:
in response to a global modification operation on the video production elements corresponding to any of the video production outlines, modifying the initial video script to generate the target video script, the global modification operation including a deletion operation, a sequence adjustment operation or an addition operation; or
in response to a local modification operation on any of the video production elements corresponding to any of the video production outlines, modifying the initial video script based on input content corresponding to the local modification operation, to generate the target video script.

9. The method according to claim 8, wherein the modifying the initial video script based on input content corresponding to the local modification operation to generate the target video script in response to a local modification operation on any of the video production elements corresponding to any of the video production outlines comprises:
in response to a triggering operation on the shooting sample material, displaying a material replacement control in a first area on the first page;
in response to a triggering operation on the material replacement control, displaying a shooting control in a second area on the first page;
in response to a triggering operation on the shooting control, displaying a shooting preview screen at the shooting angle corresponding to the triggered shooting sample material; and
in response to a shooting operation on the shooting preview screen, generating a local shooting material, and replacing the triggered shooting example material with the local shooting material to generate the target video script.

10. The method according to claim 9, wherein after the displaying a material replacement control in a first area on the first page in response to a triggering operation on the shooting sample material, the method further comprises:
in response to a triggering operation on the material replacement control, displaying a material selection control in a third area on the first page;
in response to a triggering operation on the material selection control, displaying a second page, and displaying each stored material in a local storage space on the second page;
in response to a selection operation on any of the stored materials on the second page, replacing the triggered shooting example material with the selected stored material to generate the target video script.

11. An electronic device, comprising:
a memory storing a computer program thereon; and
a processor for execution of the computer program in the memory to perform:
receiving input content, the input content used for characterizing video production requirements;
generating an initial video script based on the input content, the initial video script including a video production outlines and video production elements corresponding to the video production outlines, the video production elements including shooting information and copywriting content corresponding to the video production outline, the shooting information including at least one of a shooting location, a shooting angle, a shooting prop and a shooting sample material, the initial video script being used to assist a video creator in video creation; and
displaying the initial video script on a first page.

12. The electronic device according to claim 11, wherein the generating an initial video script based on the input content comprises:
generating the initial video script based on a video type corresponding to the input content, the video production outline and the video production elements in the initial video script have a correspondence relationship with the video type.

13. The electronic device according to claim 12, wherein the generating the initial video script based on a video type corresponding to the input content comprises:
identifying the video type corresponding to the input content using a preset script generation model;
generating the initial video script using the preset script generation model based on a video production style corresponding to the video type and a keyword of the input content, wherein the video production style is used for characterizing the correspondence relationship.

14. The electronic device according to claim 11, wherein the displaying the initial video script on a first page comprises:
displaying the initial video script in a target structured style on the first page.

15. The electronic device according to claim 11, wherein after the displaying the initial video script on a first page, the method further comprises:
displaying a video editing control on the first page;
in response to a triggering operation on the video editing control, importing each target shooting material corresponding to the video production outlines into a video production function module, the target shooting materials including the shooting example material corresponding to the initial video script and/or a local material corresponding to a target video script, the local material including local shooting materials or stored materials in a local storage space, the target video script obtained by modifying the initial video script;
displaying a video production interface corresponding to the video production function module, and displaying video editing materials in the video production interface, the video editing materials obtained based on the input content, the video editing materials including at least one of a video special effect, a matching music, an associated knowledge link and an associated product link; and
in response to an interactive operation on the video production interface, generating target video content corresponding to the video production requirements based on the target shooting materials and the video editing materials.

16. The electronic device according to claim 11, wherein after the displaying the initial video script on a first page, the method further comprises:
displaying a script editing control on the first page;
receiving a script editing instruction in response to a triggering operation on the script editing control;
modifying the initial video script, in response to the script editing instruction, to generate a target video script, the target video script used to assist a video creator in video creation.

17. A non-transitory computer-readable storage medium, having a computer program stored thereon, which, when executed by a processor, causes the processor to perform:
receiving input content, the input content used for characterizing video production requirements;
generating an initial video script based on the input content, the initial video script including a video production outlines and video production elements corresponding to the video production outlines, the video production elements including shooting information and copywriting content corresponding to the video production outline, the shooting information including at least one of a shooting location, a shooting angle, a shooting prop and a shooting sample material, the initial video script being used to assist a video creator in video creation; and
displaying the initial video script on a first page.

18. The non-transitory computer-readable storage medium according to claim 17, wherein the generating an initial video script based on the input content comprises:
generating the initial video script based on a video type corresponding to the input content, the video production outline and the video production elements in the initial video script have a correspondence relationship with the video type.

19. The non-transitory computer-readable storage medium according to claim 18, wherein the generating the initial video script based on a video type corresponding to the input content comprises:
identifying the video type corresponding to the input content using a preset script generation model;
generating the initial video script using the preset script generation model based on a video production style corresponding to the video type and a keyword of the input content, wherein the video production style is used for characterizing the correspondence relationship.

20. The non-transitory computer-readable storage medium according to claim 17, wherein the displaying the initial video script on a first page comprises:
displaying the initial video script in a target structured style on the first page.
